(19) United States
(12) Patent Application Publication
(10) Pub. No.: US 2004/0083293 A1
(43) Pub. Date: Apr. 29, 2004

(54) Ethernet addressing via physical location for massively parallel systems

(76) Inventors: Dong Chen, Croton-On-Hudson, NY (US); Paul W. Coteus, Yorktown Heights, NY (US); Alan G. Gara, Mount Kisco, NY (US); Mark E. Giampapa, Irvington, NY (US); Todd E. Takken, Mount Kisco, NY (US)

Correspondence Address: SCULLY SCOTT MURPHY & PRESSER, PC, 400 GARDEN CITY PLAZA, GARDEN CITY, NY, 11530

(21) Appl. No.: 10/469,003

(22) PCT Filed: Feb. 25, 2002
(86) PCT No.: PCT/US02/05570

(51) Int. Cl. G06F 15/16

(52) U.S. Cl. 709/227

(57) ABSTRACT

In a massively parallel system, a method and apparatus for uniquely assigning a MAC address to a device encodes the MAC address with a physical location of the device. The method and apparatus include configuring device interconnections of the parallel system with physical topological information such as a rack number, a midplane number, a card number, and a chip number. A device or node with a physical location encoded MAC address may then be interrogated by location for test, diagnostic, and program loading purposes.

### CROSS REFERENCE

The present invention claims the benefit of commonly-owned, co-pending U.S. Provisional Patent Application Serial No. 60/271,124 filed Feb. 24, 2001 entitled MASSIVELY PARALLEL SUPERCOMPUTER, the whole contents and disclosure of which is expressly incorporated by reference herein as if fully set forth herein. This patent application is additionally related to the following commonly-owned, co-pending United States Patent Applications filed on even date herewith, the entire contents and disclosure of each of which is expressly incorporated by reference. herein as if fully set forth herein. U.S. patent application Serial No. (YOR920020027US1, YOR920020044US1 (15270)), for “Class Networking Routing”; U.S. patent application Serial No. (YOR920020028US1 (15271)), for “A Global Tree Network for Computing Structures”; U.S. patent application Serial No. (YOR920020029US1 (15272)), for ‘Global Interrupt and Barrier Networks”; U.S. patent application Serial No. (YOR920020030US1 (15273)), for ‘Optimized Scalable Network Switch”; U.S. patent application Serial No. (YOR920020031US1, YOR920020032US1 (15258)), for “Arithmetic Functions in Torus and Tree Networks’; U.S. patent application Serial No. (YOR920020033US1, YOR920020034US1 (15259)), for ‘Data Capture Technique for High Speed Signaling”; U.S. patent application Serial No. (YOR920020035US1 (15260)), for ‘Managing Coherence Via Put/Get Windows’; U.S. patent application Serial No. (YOR920020036US1, YOR920020037US1 (15261)), for “Low Latency Memory Access And Synchronization”; U.S. patent application Serial No. (YOR920020038US1 (15276), for ‘Twin-tailed Fail-Over for Fileservers Maintaining Full Performance in the Presence of Failure”; U.S. patent application Serial No. (YOR920020039US1 (15277)), for “Fault Isolation Through No-Overhead Link Level Checksums’; U.S. patent application Serial No. (YOR920020040US1 (15278)), for “Ethernet Addressing Via Physical Location for Massively Parallel Systems”; U.S. YOR920020040US1 patent application Serial No. (YOR920020041US1 (15274)), for “Fault Tolerance in a Supercomputer Through Dynamic Repartitioning”; U.S. patent application Serial No. (YOR920020042US1 (15279)), for “Checkpointing Filesystem”; U.S. patent application Serial No. (YOR920020043US1 (15262)), for “Efficient Implementation of Multidimensional Fast Fourier Transform on a Distributed-Memory Parallel Multi-Node Computer”; U.S. patent application Serial No. (YOR9-20010211US2 (15275)), for “A Novel Massively Parallel Supercomputer”; and U.S. patent application Serial No. (YOR920020045US1 (15263)), for “Smart Fan Modules and System”.

### 1. FIELD OF THE INVENTION

Applicants claim the priority benefits under 35 U.S.C. §119(e) of U.S. Provisional Application Serial No. 60/271,124, filed Feb. 24, 2001, the disclosure of which is incorporated herein by its reference.

The present invention broadly relates to a method of assigning addresses to electronic devices. More particularly, it relates to a method of assigning an encoded unique hardware address to a computational device node, where the encoding represents the physical address of the computational device node.

### 2. BACKGROUND OF THE INVENTION

A well known standard for computer data networking, the Open Systems Interconnection (OSI) standard, specifies several layers of interconnection for the purpose of compatible data communications system design. One such layer is the Data Link Layer. This layer represents the transmission medium through which network devices communicate between the layer below it, the Physical Layer where the hardware is connected, and the immediate layer above it, the Network Layer.

OSI specifies several alternate media at the Data Link Layer, one such medium is the Ethernet. Whichever medium is used at the Data Link Layer, must contain a unique hardware address for each device on the network. This unique hardware address, also known as a Medium Access Control (MAC) address is the same as a unique address for the medium used, e.g., an Ethernet address. Therefore, the MAC address of a device and its Ethernet address are the same unique number. As currently generally implemented, for Ethernet, the MAC address is a 48 bit number usually expressed as 12 hexadecimal digits. Under the well known current address mapping scheme, the most significant 6 hexadecimal digits encodes the hardware device manufacturer, e.g. 08005A for IBM. The least significant 6 hexadecimal digits encodes a serial number for the devices manufactured by the hardware device manufacturer.

In a related disclosure of U.S. Provisional Application Serial No. 60/271,124 “A Novel Massively Parallel Supercomputer”, therein is described a semiconductor device with two electronic processors within each node of a multi-computer. Within the multi-computer, there is a plurality of high speed internal networks, and an external network employing Ethernet.

In the massively parallel computer system described above, 162,000 different Ethernet addresses are expected to be deployed. This large number of Ethernet. addresses creates a significant problem for a host computer, as well as intermediate network routers and switches, all of which must keep track of the MAC address for a variety of purposes including test, diagnostics, initial program loading, etc. For example, if a particular device's MAC address is not responding during a test, the physical location of the device must be determined for further testing and diagnostics. This problem of finding the device is magnified, when as in a massively parallel computer system, many nodes are arranged in many different locations. For example, the supercomputer nodes which are to be assigned MAC addresses are computer chips which physically reside on cards. The cards are mounted on boards called midplanes. The midplanes are in turn mounted in racks. Thus, the rack, midplane, board, card and chip must somehow be isolated when the only thing known about a failed device is its MAC address. While there is no known prior art that associates a physical location to a device's MAC address, it would be desirable to solve this problem by creating such an association.

### SUMMARY OF THE INVENTION

Therefore, it is an object of the present invention to provide a method and device for uniquely assigning a physical location encoded MAC address to a device. A further object of the present invention is to provide a method and device for uniquely assigning a physical location encoded MAC address to the device, where the MAC address is encoded by an external interface to the device.

Yet another object of the current invention is to provide a method and device for uniquely assigning a physical location encoded MAC address to the device, where a data link medium is Ethernet, and a corresponding Ethernet address is the same as the encoded MAC address.

A further object of the current invention is to provide a method and device for uniquely assigning a physical location encoded MAC address to the device, where the data link medium is any medium which currently exists or may be developed for communication at the Data Link Layer, and the corresponding data link medium address is the same as the encoded MAC address.

An even further object of the current invention is to provide a method and device for determining the physical location of any of a plurality of interconnected devices for the purpose of testing, diagnostics, program loading and monitoring the devices in a massively parallel system.

These and other objects and advantages may be obtained in the present invention by providing a method and device that encodes a physical location into a MAC address and uniquely assigns the physical location encoded MAC address to a device.

Specifically, there is provided a method for uniquely assigning a MAC address to a device which comprises: configuring device interconnections to encode the MAC address to a physical location of the device; using the encoded MAC address as a unique Ethernet address; using the wiring to encode a predetermined number of unique bits in the MAC address; assigning the predetermined number of unique bits to a value representing hardware device coordinates, such as rack number, midplane number, card number, and chip number to the device physical location.

### BRIEF DESCRIPTION OF THE DRAWINGS

The present invention will now be described in more detail by referring to the drawings that accompany the present application. It is noted that in the accompanying drawings like reference numerals are used for describing like and corresponding elements thereof.

FIG. 1 shows the physical layout of the hardware environment of the present invention;

FIG. 2 shows the compute node interconnections through an Ethernet switch;

FIG. 3 shows the prior art MAC address byte structure;

FIG. 4 shows the MAC address byte structure of the present invention; and

FIG. 5 shows an example of physical address encoding on a mounting surface of the present invention.

An aspect of this invention applies to an external Ethernet based network. A preferred embodiment of this invention encodes a physical location of a node in the Ethernet “MAC” hardware address which is assigned through a combination of the particular Rack containing the Node, the particular midplane containing the node, and the particular node-card containing the node.

In a preferred embodiment of this invention, every Ethernet packet sent by the supercomputer to the host machine uniquely identifies the physical location of the node generating the packet and allows that information to be used to track problems to specific nodes in the machine. Another aspect of this invention can also uniquely identify a geographical location as part of the physical location.

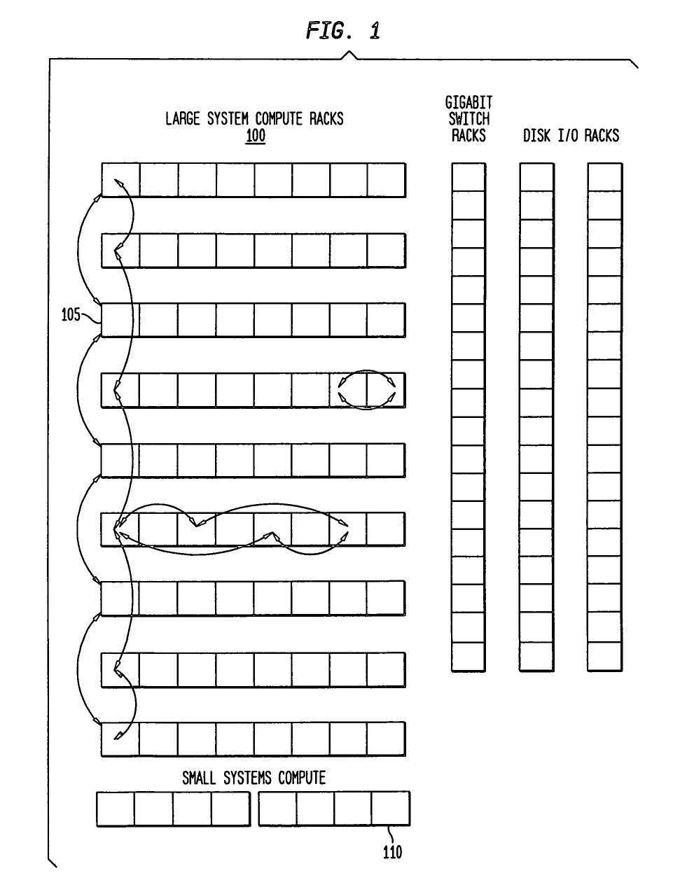

In one aspect of this invention, as shown in the example of FIG. 1, there are physically 80 system compute racks 105, 110. As discussed above, a number of midplanes occupy each rack, for example 2 midplanes per rack. Additionally there are a number of cards, e.g., 64 cards, that occupy each midplane. Each card has a number of network addressable chips, e.g., 9 chips. And, in a preferred aspect of this invention, each network addressable chip on the card represents one of a plurality of compute nodes 205.

According to the above example, the predetermined number of bits needed to represent the physical location of any node is 18 bits. The number of bits is derived by multiplying the locations as follows:

9 chips ×64 cards ×2 midplane ×80 racks=92,160 unique locations within a system. That number is then converted to hexadecimal which is 16800 h, representing 18bits of information.

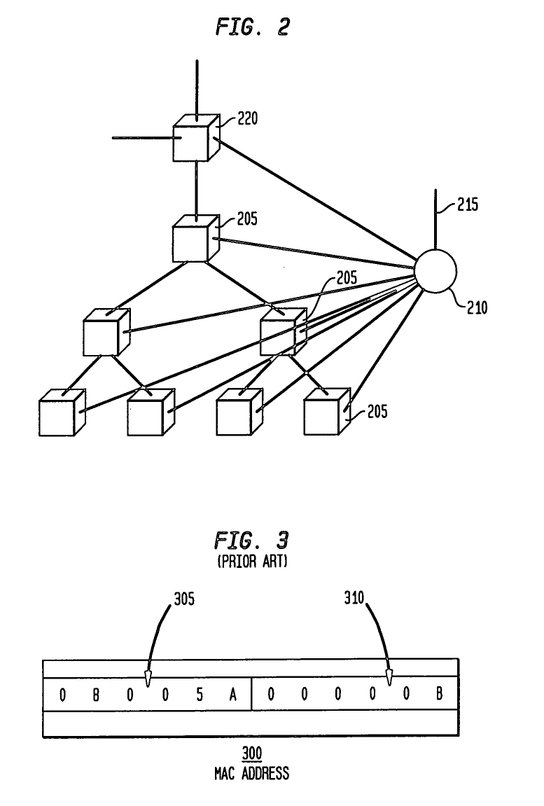

FIG. 2 shows the network environment in which the compute nodes 205 communicate using switch 210 for Ethernet data link 215. Under these conditions, the 48 bit Ethernet MAC address is well suited for carrying the physical location information. As shown in FIG. 3, the 48 bit MAC address is broken down into a most significant part (MSP) 305 and a least significant part (LSP) 310.

The prior art method allocates the MSP to a manufacturer such as IBM as shown, MSP 310 is 08005A for IBM. Under the prior art method, the LSP 310 is allocated for serial numbers.

Under the inventive method, the MSP 405 is still reserved for the manufacturer identification, e.g. IBM. However, the LSP is now allocated as a physical location descriptor 410. The physical location descriptor may define a device location such as the location of compute node 205, by rack, midplane, card and chip as described above. The example physical location descriptor 410 is shown to have a 7 R bit field to identify a rack number, a 1 m bit field to identify a midplane, a 6 a bit field to identify a card number, and a 4 h bit field to identify a computing device number. Thus, as shown, the physical location of a node is completely described. Moreover, the x bits shown in the LSP, FIG. 4 are extra bits which could be used to describe device, e.g., node physical location in an even larger physical topology.

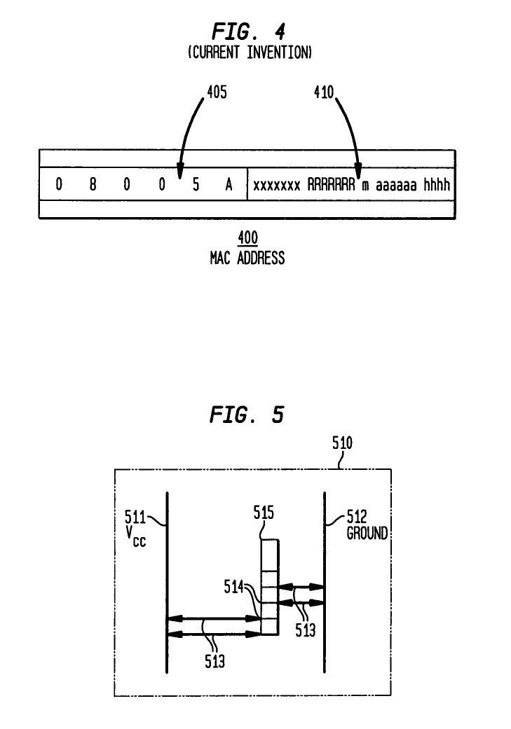

A preferred aspect of the present invention uses a hard wired programming technique to encode physical location, such as shown in the example in FIG. 5. It should be noted that while wiring is discussed and shown here, any means of configuring device interconnections, such as optoelectronic means, for example, may be employed within the scope of the present invention. A mounting surface 510, e.g., a midplane has a slot connector 515 with connections 513 going to either a positive voltage, V_{cc} 511 or ground 512. In this manner, the voltage levels may be used to encode a predetermined number of bits corresponding to the physical topology of the interfaces. In a similar fashion, the card could be wired to encode a chip position number for each chip, i.e., node on the card. Also system level wiring connecting the racks together could be configured to encode a rack number that gets propagated through the midplane, and on to the card. Similarly, rack level wiring is configured to encode a midplane number, while midplane wiring is configured to encode a card number. Finally, card level wiring could be configured to identify, i.e., encode a compute node number. When power is applied to the system, an electrically erasable programmable read only memory (EEPROM) (not shown) could be used to store the encoded bits for configuration of the MAC address for the connected device, e.g. node.

An alternative technique for entering the physical location encoding bits into the device or node would be to program the physical location encoded MAC address for each node by using that node's IEEE 1149.1 JTAG interface. It is known in the art that communication with a JTAG-compliant device, such as any of compute nodes 205 is achieved by utilizing a host computer, such as for example, a hardware controller that has a connection to a JTAG-compliant card containing the compute nodes 205. The JTAG-compliant devices, e.g., compute nodes must connect to all flash memory address, data and control signals. Flash memory does not need to be JTAG-compliant for this programming method to function. The host computer sends commands and data to the JTAG-compliant device, e.g., any of compute nodes 205, then propagates the data to the flash memory for programming. In this manner, the host computer provides a communication link with any of the compute nodes 205 for accomplishing the physical location encoding of the MAC address. The JTAG capabilities of a preferred environment of this invention are discussed in the provisional application No. 60/271,124 which has been incorporated by reference herein.

During system operation, a MAC address transmitted by a connected device as described above may be interrogated by switches, network monitors, and host computers to determine the exact physical location of the device. This capability provides for improved management, diagnostics and debug functionality of the parallel computing system. Additionally, when TCP/IP addresses are assigned, such as in a system running the Dynamic Host Configuration Protocol (DHCP), the TCP/IP address becomes an equally valid indicator of the device location.

Now that the invention has been described by way of a preferred embodiment, various modifications and improvements will occur to those of skill in the art. Thus, it should be understood that the preferred embodiment is provided as an example and not as a limitation. The scope of the invention is defined by the appended claims.

What is claimed is:

1. In a massively parallel computing system comprising a plurality of nodes configured in three dimensions, each node including a computing device, a method for uniquely assigning a MAC address to the computing device, comprising:
programming the computing device to encode the MAC address to a physical location of the computing device;
using a predetermined number of bits of the MAC address for the encode step, wherein the physical location of the computing device is uniquely described.

2. The method for MAC address assigning of claim 1, wherein the MAC address is uniquely associated with an Ethernet address.

3. The method for MAC address assigning of claim 1, wherein the programming of the computing device is based on a predetermined wiring configuration of a unique rack, midplane, and card containing the computing device.

4. The method for MAC address assigning of claim 1, wherein the programming of the computing device is based on instructions from a host computer.

5. The method for MAC address assigning of claim 4, wherein the host computer instructions comprise IEEE 1149.1 JTAG signals.

6. The method for MAC address assigning of claim 1, wherein the predetermined number of bits of the MAC address comprises a least significant part of the MAC address.

7. The method for MAC address assigning of claim 6, wherein the least significant part of the MAC address includes a physical location descriptor, comprising:
a compute rack field;
a midplane field;
a card field; and
a computing device field.

8. The method for MAC address assigning of claim 2, wherein the Ethernet address is uniquely associated with a TCP/IP address.

9. The method for MAC address assigning of claim 1, further comprising:
using the MAC address for management of the parallel computing system;
using the MAC address for diagnostics of the parallel computing system; and
using the MAC address for debug functions of the parallel computing system.

10. In a massively parallel computing system comprising a plurality of nodes configured in three dimensions, each node including a computing device, an apparatus for uniquely assigning a MAC address to the computing device, comprising:
a.) a system interconnect configuration, creating a compute rack encoded position of a compute rack location relative to a plurality of compute racks in the massively parallel computing system, wherein the compute rack encoded position is used to program a predetermined number of bits in a compute rack field of the MAC address of the computing device for uniquely describing the compute rack location of the computing device.
b.) a compute rack interconnect configuration, creating a midplane encoded position of a midplane location relative to a plurality of midplanes connected to the compute rack, wherein the midplane encoded position is used to program a predetermined number of bits in a midplane field of the MAC address of the computing device for uniquely describing the midplane location of the computing device.
c.) a midplane interconnect configuration, creating a card encoded position of a card location relative to a plurality of cards connected to the midplane, wherein the card encoded position is used to program a predetermined number of bits in a card field of the MAC address of the computing device for uniquely describing the card location of the computing device.
d.) a card interconnect configuration, creating a computing device encoded position of a computing device location relative to a plurality of computing devices connected to the card, wherein the computing device encoded position is used to program a predetermined number of bits in a computing device field of the MAC address of the computing device for uniquely describing the computing device location on the card.

11. The apparatus for assigning a MAC address of claim 10, wherein the MAC address is uniquely associated with an Ethernet address.

12. The apparatus for assigning a MAC address of claim 10, wherein a least significant part of the MAC address comprises the compute rack field, the midplane field, the card field, and the computing device field.

13. The apparatus for assigning a MAC address of claim 11, wherein the Ethernet address is uniquely associated with a TCP/IP address.

14. The apparatus for assigning a MAC address of claim 10, comprising:
means for using the MAC address for management of the parallel computing system;
means for using the MAC address for diagnostics of the parallel computing system; and
means for using the MAC address for debug functions of the parallel computing system.
